(19) United States
(12) Patent Application Publication
(10) Pub. No.: US 2017/0050359 A1
(43) Pub. Date: Feb. 23, 2017

(54) INJECTION MOLDING APPARATUS

(71) Applicants: AISIN SEIKI KABUSHIKI KAISHA, Kariya-shi (JP); THE DOSHISHA, Kyoto-shi (JP); TOYO MACHINERY & METAL CO., LTD., Akashi-shi (JP)

(72) Inventors: Ryohei HIGUCHI, Obu-shi (JP); Akira Inoue, Akashi-shi (JP); Sou Shimokusuzono, Akashi-shi (JP); Tatsuya Tanaka, Kyotanabe-shi (JP); Akimitsu Iwasaki, Kyotanabe-shi (JP)

(73) Assignees: AISIN SEIKI KABUSHIKI KAISHA, Kariya-shi (JP); THE DOSHISHA, Kyoto-shi (JP); TOYO MACHINERY & METAL CO., LTD., Akashi-shi (JP)

(21) Appl. No.: 15/233,078

(22) Filed: Aug. 10, 2016

(30) Foreign Application Priority Data
Aug. 19, 2015 (JP) 2015-161505

(51) Int. Cl. B29C 45/18; B29C 45/00; B29C 45/03

(52) U.S. Cl. CPC B29C 45/1866; B29C 45/03; B29C 45/0005; B29K 2023/12

(57) ABSTRACT

An injection molding apparatus includes: an injection cylinder having a tip opening communicating with a cavity of a molding die; a resin supply portion configured to supply thermoplastic resin to a space in the injection cylinder; a reinforced fiber supply portion configured to supply fiber reinforced aggregates to the space in the injection cylinder; and a screw rotatably disposed in the injection cylinder, the screw being configured to compress and knead the thermoplastic resin in the injection cylinder and defibrate the fiber reinforced aggregates so as to disperse the fiber reinforced aggregates in the thermoplastic resin. The resin supply portion and the reinforced fiber supply portion are provided as different bodies. The reinforced fiber supply portion is placed on a tip opening side relative to the resin supply portion. The screw has a uniform groove depth.

### INCORPORATION BY REFERENCE

The disclosure of Japanese Patent Application No. 2015-161505 filed on Aug. 19, 2015 including the specification, drawings and abstract is incorporated herein by reference in its entirety.

### BACKGROUND OF THE INVENTION

1. Field of the Invention

The present invention relates to an injection molding apparatus.

2. Description of Related Art

International Publication No. 2014/170932 is an example of an injection molding apparatus. The injection molding apparatus includes: an injection cylinder having a tip opening communicating with a cavity of a molding die; a resin supply hopper (a resin supply portion) and a twin-shaft screw feeder (a reinforced fiber supply portion) each fixed to an upper part of the injection cylinder; and a screw disposed inside the injection cylinder. The resin supply hopper and the twin-shaft screw feeder are fixed to the injection cylinder in a state that they are arranged in an axis direction of the injection cylinder. More specifically, the twin-shaft screw feeder is placed on a side closer to the tip opening of the injection cylinder than the resin supply hopper. The screw is disposed coaxially and rotatably in the injection cylinder.

The injection molding using the injection molding apparatus is performed such that, in a state where the injection cylinder is heated and the screw is rotated, thermoplastic resin is supplied to the resin supply hopper and fiber reinforced aggregates are supplied to the twin-shaft screw feeder. The fiber reinforced aggregate is obtained by connecting (bundling up) many reinforced fibers. The thermoplastic resin supplied to the resin supply hopper is sent to the injection cylinder from the resin supply hopper. As a result, the thermoplastic resin melts by heat of the injection cylinder, and is compressed and kneaded by the screw that rotates. Further, the thermoplastic resin is sent to a tip end side of the injection cylinder by a thrust of the screw. The fiber reinforced aggregates thus supplied to the twin-shaft screw feeder are sent into the injection cylinder from the twin-shaft screw feeder. Then, the fiber reinforced aggregates are defibrated by the screw to be reinforced fibers. The reinforced fibers are dispersed in the thermoplastic resin, and are further sent to the tip end side of the injection cylinder due to the thrust of the screw together with the thermoplastic resin.

The thermoplastic resin including the reinforced fibers that are sent to a tip-opening side (tip end side) of the injection cylinder by the screw is emitted from the tip opening of the injection cylinder to the cavity of the molding die. After the thermoplastic resin including the reinforced fibers is solidified in the cavity, the molding die is opened. Hereby, a desired resin molded product is obtained.

### SUMMARY OF THE INVENTION

Material properties (for example, rigidity) of the resin molded product molded by use of the thermoplastic resin including the reinforced fibers have a deep relationship to the length of the reinforced fibers in the resin molded product. That is, as the length of the reinforced fibers in the resin molded product becomes longer, better material properties of the resin molded product can be obtained. In other words, as the length of the reinforced fibers in the resin molded product becomes shorter, the material properties of the resin molded product are worsened.

However, in terms of a groove depth of the screw of the injection molding apparatus of International Publication No. 2014/170932, the groove depth is shallower in a part on a tip end side of the screw than in a part opposed to the twin-shaft screw feeder. Further, it is known that, as the groove depth of the screw is shallower (smaller), the reinforced fibers are easily sheared by the thrust of the screw. Accordingly, the reinforced fibers sent into the injection cylinder from the twin-shaft screw feeder are easily sheared by a thrust generated by the part on the tip end side of the screw. That is, the reinforced fibers easily become largely shorter than the reinforced fibers right after the supply to the injection cylinder from the twin-shaft screw feeder. Accordingly, a resin molded product molded by the injection molding apparatus of International Publication No. 2014/170932 possibly has low material properties.

The present invention provides an injection molding apparatus that is able to restrain an overall length of reinforced fibers dispersed in thermoplastic resin inside an injection cylinder from becoming largely shorter than the reinforced fibers right after the reinforced fibers are supplied to the injection cylinder from a reinforced fiber supply portion.

An injection molding apparatus of an aspect of the present invention includes: an injection cylinder having a tip opening communicating with a cavity of a molding die; a resin supply portion configured to supply thermoplastic resin to a space in the injection cylinder; a reinforced fiber supply portion configured to supply fiber reinforced aggregates to the space in the injection cylinder; and a screw rotatably disposed in the injection cylinder, the screw being configured to compress and knead the thermoplastic resin in the injection cylinder and defibrate the fiber reinforced aggregates so as to disperse the fiber reinforced aggregates in the thermoplastic resin. The resin supply portion and the reinforced fiber supply portion are provided as different bodies. The reinforced fiber supply portion is placed on a tip opening side relative to the resin supply portion. The screw has a uniform groove depth.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a side view of a section of an injection cylinder of an injection molding apparatus according to an embodiment of the present invention;

FIG. 2 is a table illustrating components and properties of resin molded products molded by respective injection molding apparatuses according to the embodiment, Comparative Example 1, and Comparative Example 2;

FIG. 3 is a graph illustrating a relationship between a fiber length and properties (rigidity, strength, and impact resistance in the present embodiment) of reinforced fibers in the resin molded product;

FIG. 4 is a side view of the injection molding apparatus of Comparative Example 1, similarly to FIG. 1,

FIG. 5 is a side view of the injection molding apparatus of Comparative Example 2, similarly to FIG. 1.

### DETAILED DESCRIPTION OF EMBODIMENTS

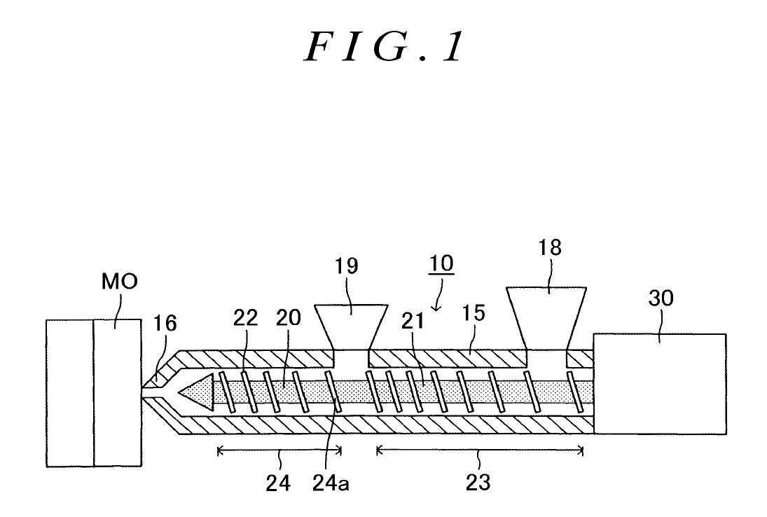

One embodiment of the present invention will be described below with reference to the drawings. An injection molding apparatus 10 of the present embodiment has the following structure. As illustrated in FIG. 1, the injection molding apparatus 10 of the present embodiment includes, as large constituents, an injection cylinder 15, a primary hopper 18, a secondary hopper 19, a screw 20 disposed inside the injection cylinder 15, and a drive unit 30.

The injection cylinder 15 is a generally cylindrical member extending linearly. A nozzle 16 is attached to a tip opening (a left end in FIG. 1) of the injection cylinder 15. The nozzle 16 is connected to a molding die MO, and the nozzle 16 communicates with a cavity in the molding die MO. A heater (not shown) is attached to the injection cylinder 15.

As illustrated in FIG. 1, the primary hopper 18 (an example of a resin supply portion) and the secondary hopper 19 (an example of a reinforced fiber supply portion) are fixed to an upper part of the injection cylinder 15. A fixed position of the secondary hopper 19 to the injection cylinder 15 is on a front side (the left side in FIG. 1) relative to a fixed position of the primary hopper 18 to the injection cylinder 15. Upper and lower parts of the primary hopper 18 and the secondary hopper 19 are opened, and their lower openings communicate with an internal space of the injection cylinder 15.

The screw 20 is disposed in the internal space of the injection cylinder 15 so as to be coaxial with the injection cylinder 15. The screw 20 is rotatable around its own axis and slidable in its axis direction. The drive unit 30 is connected to a rear end (a right end in FIG. 1) of the screw 20. The drive unit 30 includes a drive source (e.g., an electric motor) that generates a driving force to rotate and slide the screw 20.

The screw 20 integrally includes a columnar shaft portion 21, and a spiral flight portion 22 (blade) projecting from an outer peripheral surface of the shaft portion 21. The shaft portion 21 has a circular column shape except a tip end (a part constituting a conical left end portion in FIG. 1). That is, an outside diameter D of a part of the shaft portion 21 except its tip end is uniform. The flight portion 22 is constituted by a first constituent part 23 and a second constituent part 24, which are continuous with each other. The first constituent part 23 is a part constituting about half of the flight portion 22 on a drive-unit-30 side, and its end portion on the drive-unit-30 side is opposed to the lower opening of the primary hopper 18 in an up-down direction. The second constituent part 24 is a part constituting about half of the flight portion 22 on a tip end side, and its end portion on a first-constituent-part-23 side constitutes an opposed part 24a opposed to the lower opening of the secondary hopper 19 in the up-down direction. A pitch of the first constituent part 23 and a pitch of the second constituent part 24 are both variable pitches. That is, the pitch of the first constituent part 23 gradually decreases as it goes toward an opposed-part-24a side from the drive-unit-30 side, and the pitch of the second constituent part 24 gradually decreases as it goes toward the tip end side from the opposed-part-24a side. As illustrated in the figure, the pitch at the opposed part 24a of the second constituent part 24 is larger than a pitch at an end (a part adjacent to the opposed part 24a from the drive-unit-30 side) of the first constituent part 23. A compression ratio of the first constituent part 23 of the screw 20 is 2.0 or more. Meanwhile, a compression ratio of the second constituent part 24 of the screw 20 is larger than 1.0, but is smaller than the compression ratio of the first constituent part 23. For example, in a case where the compression ratio of the first constituent part 23 is set to 2.3, the compression ratio of the second constituent part 24 can be set to 2.2, for example. A groove depth H, however, is the same at any position in the flight portion 22.

Next will be described an injection molding method using the injection molding apparatus 10 having the above configuration. First, the heater provided in the injection cylinder 15 is operated to increase a temperature in the injection cylinder 15 to a desired temperature, and further, the drive unit 30 is operated to rotate the screw 20 in one direction (a positive direction). Further, many resin pellets and a modifier (anhydrous carboxylic acid-modified PP) are put into the primary hopper 18, and many fiber reinforced aggregates are put into the secondary hopper 19.

The resin pellet is thermoplastic resin and is polypropylene (PP) resin in the present embodiment. Note that, as the resin pellet (thermoplastic resin), resins such as engineering plastic or super engineering plastic can be employed other than PP. Further, depending on prescribed properties of a molded product to be molded, additives (colorant, light stabilizer, and the like) other than the modifier may be supplied from the primary hopper 18 to the injection cylinder 15.

The fiber reinforced aggregate is an aggregate of chopped-strand reinforced fibers. The “aggregate of chopped-strand reinforced fibers” is an aggregate of reinforced fibers formed by combining a plurality of reinforced fibers having a very small diameter (e.g., 10 μm) and a predetermined length by a sizing agent. In the present embodiment, a glass fiber is employed as the reinforced fiber, and a chopped-strand fiber reinforced aggregate in which about 3000 to 6000 reinforced fibers are connected and bundled up together by the sizing agent is used. A width (that is, a fiber length of each of the reinforced fibers) of the fiber reinforced aggregate is around 9 mm. As the reinforced fiber, general fillers including an organic filler such as a glass fiber or a carbon fiber and an inorganic filler such as calcium carbonate or talc can be employed, for example. Note that a roving-shaped reinforced fiber bundle may be cut with a desired length above the secondary hopper 19 so as to be employed as the fiber reinforced aggregate. Further, an uncut roving-shaped reinforced fiber bundle may be employed as the fiber reinforced aggregate.

The resin pellets and the modifier put into the primary hopper 18 from a first supply portion (not shown) are supplied into the injection cylinder 15. More specifically, the resin pellets and the modifier are supplied to a space between an end portion of the first constituent part 23 on the drive-unit-30 side and an inner peripheral surface of the injection cylinder 15. The resin pellets and the modifier thus supplied to the space are melted by heat of the injection cylinder 15 heated by the heater. Then, a mixture of the resin pellets and the modifier thus melted is sent to a tip end side (a nozzle-16 side) of the injection cylinder 15 by a thrust generated by the rotation of the first constituent part 23 of the screw 20. As mentioned earlier, the first constituent part 23 has a variable-pitch shape in which the pitch gradually decreases as it goes toward the opposed-part-24a side from the drive-unit-30 side. Accordingly, the mixture of the resin pellets and the modifier thus melted is gradually compressed and kneaded as it goes toward a tip end side of the first constituent part 23, so that its viscosity decreases. That is, an ability of the first constituent part 23 having a variable pitch to plasticize the resin pellets (in other words, a production capacity of a resin molded product by the injection molding apparatus 10) is higher than that of a case where the first constituent part 23 has a constant pitch.

The mixture of the resin pellets and the modifier thus sent to the tip end side of the first constituent part 23 is sent toward the opposed part 24a of the second constituent part 24. As mentioned earlier, the pitch of the opposed part 24a of the second constituent part 24 is larger than the pitch of the end portion of the first constituent part 23 on a second-constituent-part-24 side. Accordingly, as the mixture of the resin pellets and the modifier moves from the end portion of the first constituent part 23 on the second-constituent-part-24 side to the opposed part 24a of the second constituent part 24, a pressure of the mixture of the resin pellets and the modifier decreases. This allows the injection molding apparatus 10 to restrain a vent-up phenomenon in which the mixture of the resin pellets and the modifier thus sent to the opposed part 24a of the second constituent part 24 rises toward a secondary-hopper-19 side due to a pressure of the mixture itself.

The fiber reinforced aggregates supplied to a second supply portion (not shown) connected to the secondary hopper 19 is supplied to the secondary hopper 19. Further, the fiber reinforced aggregates are supplied from the lower opening of the secondary hopper 19 to a space between the opposed part 24a of the second constituent part 24 and the inner peripheral surface of the injection cylinder 15. Since the pitch of the opposed part 24a of the second constituent part 24 is larger than the pitch of the end portion of the first constituent part 23 on the second-constituent-part-24 side, the space between the opposed part 24a of the second constituent part 24 and the inner peripheral surface of the injection cylinder 15 is large. Besides, vent-up of the mixture of the resin pellets and the modifier toward the secondary-hopper-19 side is restrained. Accordingly, the fiber reinforced aggregates supplied into the injection cylinder 15 and decreased in a bonding force between reinforced fibers are surely mixed with the mixture of the resin pellets and the modifier, a viscosity of which is decreased in vicinity of the opposed part 24a of the second constituent part 24.

As a result, a mixture of the resin pellets, the modifier, and the fiber reinforced aggregates is moved to a tip end side of the injection cylinder 15 by a thrust of the second constituent part 24. Further, since the pitch of the second constituent part 24 of the screw 20 gradually decreases toward the tip end side of the screw 20, the thrust generated by the second constituent part 24 gradually increases as it goes toward the tip end side of the screw 20. Besides, at the time when the fiber reinforced aggregates begin to be mixed with the mixture of the resin pellets and the modifier, the resin pellets and the modifier have already been decreased in viscosity. Accordingly, the fiber reinforced aggregates decreased in the bonding force between the reinforced fibers are gradually defibrated (the reinforced fibers are decomposed one by one or in a state close to this) as they move to the tip end side of the screw 20, and the reinforced fibers are generally uniformly dispersed inside the mixture of the resin pellets and the modifier.

A shear force τ that the reinforced fibers receive in the injection cylinder 15 can be expressed by the following Formula (1).

τ=π×D×N×μ/(60×H) Formula (1)

(D . . . the outside diameter of the part of the shaft portion 21 except for its tip end; N . . . the number of rotations of the screw 20 per time; μ. . . a viscosity of resin materials; and H . . . the groove depth of the screw 20) The groove depth H of the screw 20 is uniform. That is, a groove depth H of the screw 20 on the tip end side is the same as a groove depth H of the opposed part 24a of the second constituent part 24. Accordingly, the shear force t that the reinforced fibers receive via the mixture of the resin pellets and the modifier does not increase very much (further, even if the reinforced fibers move to the tip end side of the screw 20 together with the mixture of the resin pellets and the modifier due to the rotation of the screw 20, the shear force I does not increase to be larger than a shear force that the opposed part 24a of the second constituent part 24 receives). Besides, the reinforced fibers that are defibrated are mixed with the mixture of the resin pellets and the modifier, a viscosity μ of which is sufficiently lowered. Accordingly, a possibility that the reinforced fibers are broken excessively is small. Further, in order to increase the production capacity (the ability to plasticize the resin pellets) of the resin molded product by the injection molding apparatus 10, the number of rotations N of the screw 20 may be increased. The groove depth H on the tip end side of the screw 20, however, is not small (the groove depth H is uniform at any position). Therefore, even if the number of rotations N is increased, the shear force I does not become so large. Accordingly, in comparison with the reinforced fibers at the time of being supplied to the secondary hopper 19, a possibility that the reinforced fibers in the mixture of the resin pellets and the modifier are largely shortened is small.

Molten resin (the mixture of the resin pellets, the modifier, and the reinforced fibers) that is sent to the tip end side of the injection cylinder 15 by the thrust of the second constituent part 24 is emitted from the nozzle 16 to the cavity in the molding die MO. When the molding die MO is cooled down to solidify the mixture of the resin pellets, the modifier, and the reinforced fibers, and further, the molding die MO is opened, a resin molded product molded by a die surface of the molding die MO is obtained.

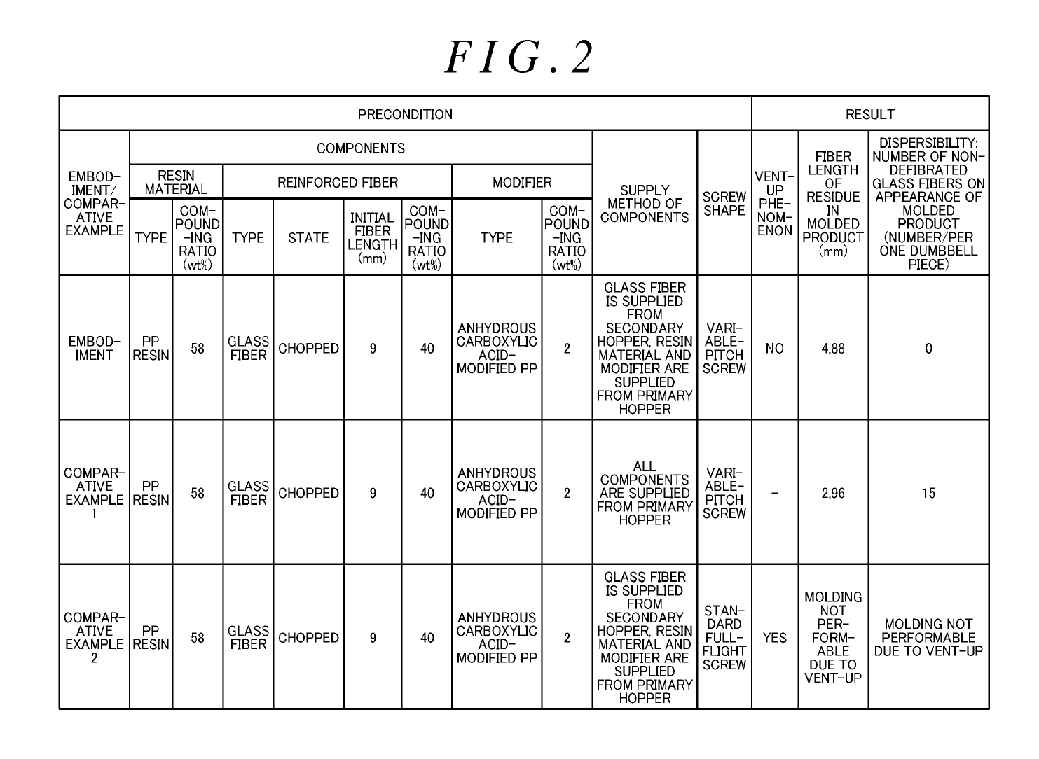

When the reinforced fibers were taken out of the molten resin emitted from the nozzle 16 and lengths thereof were measured, an average length thereof was 4.88 mm (see FIG. 2). Note that a compounding ratio of the reinforced fibers is 40 wt %, and a compounding ratio of the modifier is 2 wt %. A fiber length of the reinforced fibers before being supplied to the injection cylinder 15 (that is, the fiber length of the reinforced fibers constituting the fiber reinforced aggregates) is around 9 mm. Accordingly, a ratio (a fiber-length ratio) of the fiber length of the reinforced fibers included in the molten resin emitted from the nozzle 16, with respect to a fiber length of the reinforced fibers before being supplied to the injection cylinder 15, is about 54%.

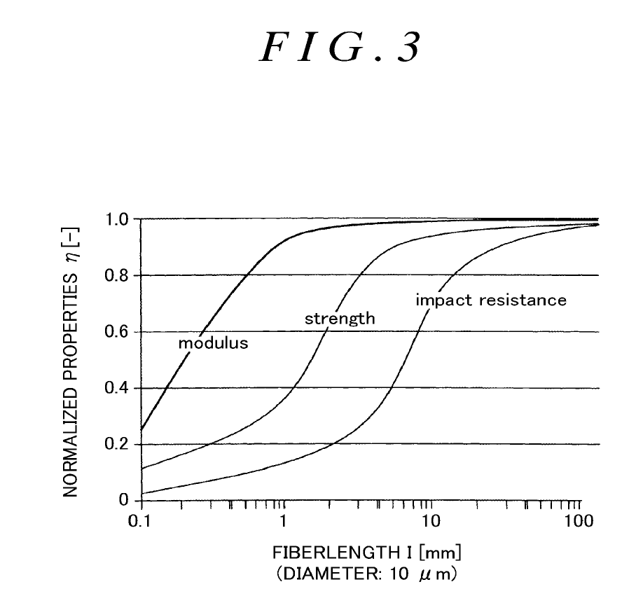

FIG. 3 is a graph illustrating a relationship between the fiber length of the reinforced fibers included in the resin molded product and material properties (e.g. rigidity, strength, and impact resistance) of a resin molding material in which the reinforced fibers are contained. In FIG. 3, a horizontal axis indicates the fiber length (Fiber length) of the reinforced fibers, and a vertical axis indicates magnitude of the material properties (Normalized Properties) of the resin molding material. As illustrated in FIG. 3, it is found that, as the fiber length of the reinforced fibers becomes longer and longer, the material properties such as the rigidity (modulus), the strength, and the impact resistance improve. As described above, the fiber length of the reinforced fibers in the resin molded product molded by use of the injection molding apparatus 10 and the molding die MO is long. In other words, in comparison with the fiber length (9 mm) at the time when the reinforced fibers are supplied to the secondary hopper 19, a possibility that the reinforced fibers are largely shortened is small. Besides, the reinforced fibers are dispersed uniformly in the resin molded product. That is, as apparent from FIG. 2, dispersibility of the reinforced fibers in the resin molded product thus molded is 0 (the reinforced fibers are dispersed more uniformly as a value indicative of the dispersibility is smaller). Accordingly, the resin molded product can show excellent material properties.

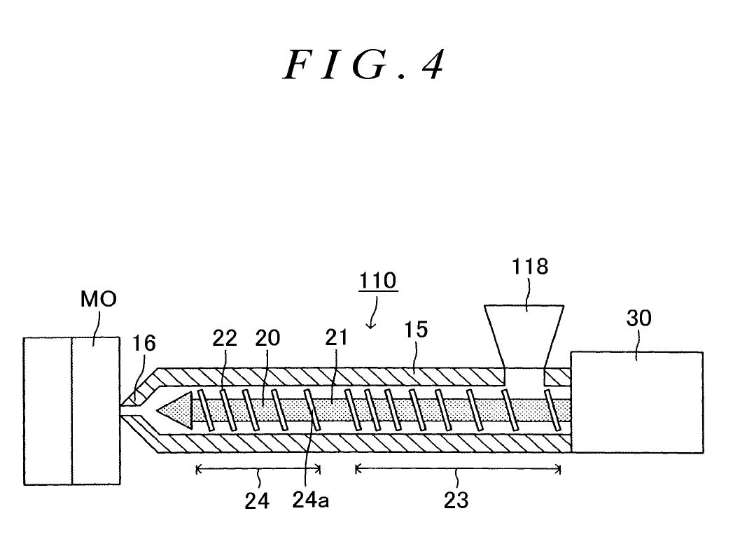

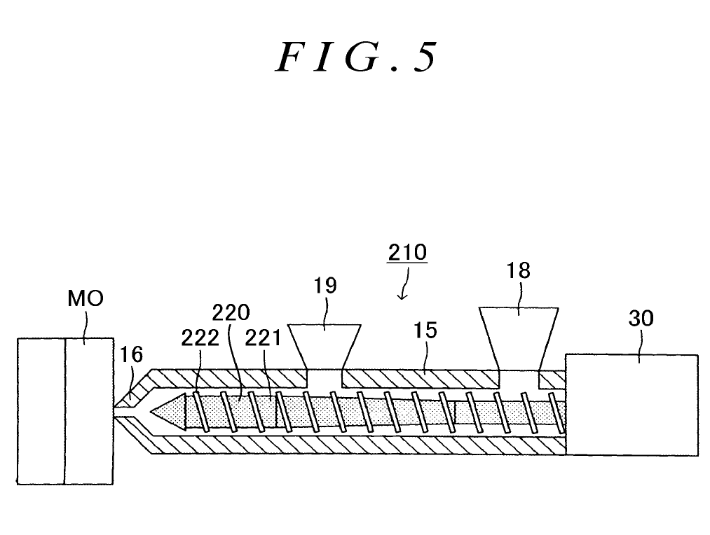

It is also apparent, from the comparison with Comparative Examples 1, 2 described below, that the resin molded product thus molded by the injection molding apparatus 10 has good material properties. An injection molding apparatus 110 of Comparative Example 1 illustrated in FIG. 4 is different from the injection molding apparatus 10 only in that the injection molding apparatus 110 includes a hopper 118 corresponding to the primary hopper 18, but does not include a hopper corresponding to the secondary hopper 19. An injection molding apparatus 210 of Comparative Example 2 illustrated in FIG. 5 is different from the injection molding apparatus 10 only in that a screw 220 is a normal full-flight screw. That is, the injection molding apparatus 210 is different from the injection molding apparatus 10 in that a pitch of a flight portion 222 of the screw 220 is constant and that a groove depth H of the screw 220 gradually decreases as it goes from a base end side of screw 220 toward a tip end side thereof (in other words, an outside diameter of a shaft portion 221 gradually increases as it goes from the base end side toward the tip end side).

In the injection molding apparatus 110 of Comparative Example 1, resin pellets, a modifier (anhydrous carboxylic acid-modified PP), and fiber reinforced aggregates are supplied to an injection cylinder 15 from one hopper 118. Accordingly, in the injection molding apparatus 110, the fiber reinforced aggregates are mixed with the resin pellets with a high viscosity μ in the injection cylinder 15. In this case, the fiber reinforced aggregates are more likely to receive a large shear force from the resin pellets. On this account, as described in FIG. 2, when reinforced fibers were taken out of molten resin (a mixture of the resin pellets, the modifier, and the reinforced fibers) emitted from a nozzle 16 and their lengths were measured, an average length thereof was 2.96 mm. Accordingly, a ratio of a fiber length of the reinforced fibers included in the molten resin emitted from the nozzle 16, with respect to a fiber length of the reinforced fibers before being supplied to the injection cylinder 15 is about 32%. Further, the fiber reinforced aggregates supplied into the injection cylinder 15 from the hopper 118 are mixed with the mixture of the resin pellets and the modifier with a high viscosity μ. On that account, the fiber reinforced aggregates are hard to defibrate and disperse in the mixture of the resin pellets and the modifier. As illustrated in FIG. 2, dispersibility of the reinforced fibers in a resin molded product molded by the injection molding apparatus 110 of Comparative Example 1 is 15. Further, in the resin molded product molded by the injection molding apparatus 110, most of the fiber reinforced aggregates remain in a state where they are not defibrated. Accordingly, the resin molded product molded by the injection molding apparatus 110 of Comparative Example 1 has poor material properties as compared with the resin molded product molded by the injection molding apparatus 10 of the present embodiment.

In the injection molding apparatus 210 of Comparative Example 2, the screw 220 is a normal full-flight screw. Accordingly, a pressure of a mixture of resin pellets and a modifier in an injection cylinder 15 becomes larger when the mixture is positioned right under a secondary hopper 19, as compared with the time when the mixture is positioned right under a primary hopper 18. On this account, when the mixture of the resin pellets and the modifier is sent right under the secondary hopper 19, the mixture is more likely to cause a vent-up phenomenon in which the mixture rises toward a secondary-hopper-19 side due to a pressure of the mixture itself. Accordingly, fiber reinforced aggregates put into the secondary hopper 19 are less likely to be supplied to the injection cylinder 15 (the fiber reinforced aggregates cannot be mixed with the mixture of the resin pellets and the modifier in the injection cylinder 15) That is, it is difficult for the injection molding apparatus 210 to mold a resin molded product including reinforced fibers (aggregates thereof). Note that, even if the mixture of the resin pellets and the modifier causes a vent-up phenomenon, the reinforced fibers (the aggregates thereof) may be partially mixed with the mixture of the resin pellets and the modifier. A groove depth H of the screw 220, however, gradually decreases as it goes from a base end side of the screw 220 toward a tip end side thereof. Accordingly, as apparent from Formula (1), the fiber reinforced aggregates receive a high shear force in the injection cylinder 15 (particularly, on the tip end side of the screw 220). On that account, the reinforced fibers are easily broken excessively on the tip end side of the injection cylinder 15 That is, in this case, the resin molded product molded by the injection molding apparatus 210 has poor material properties in comparison with the present embodiment.

The injection molding apparatus 10 of the embodiment of the present invention includes: the injection cylinder 15 having the tip opening communicating with the cavity of the molding die; the primary hopper 18 configured to supply thermoplastic resin to the space in the injection cylinder 15; the secondary hopper 19 configured to supply fiber reinforced aggregates to the space in the injection cylinder 15; and the screw 20 rotatably disposed in the injection cylinder 15, the screw 20 being configured to compress and knead the thermoplastic resin in the injection cylinder 15 and defibrate the fiber reinforced aggregates so as to disperse the fiber reinforced aggregates in the thermoplastic resin. The primary hopper 18 and the secondary hopper 19 are provided as different bodies, the secondary hopper 19 is placed on the tip opening side relative to the primary hopper 18, the screw 20 has a uniform groove depth.

In the injection molding apparatus 10, the screw 20 has a uniform groove depth. Accordingly, as compared with a case where a groove depth of the screw 20 gradually decreases as it goes toward the tip end side of the screw 20, the reinforced fibers dispersed in the thermoplastic resin in the injection cylinder 15 are less likely to be sheared by the thrust generated by the screw. Further, if the thermoplastic resin and the fiber reinforced aggregates are supplied from a common (a single) supply portion to the shot cylinder, the reinforced fibers (the aggregates) are mixed with the thermoplastic resin with a high viscosity. In this case, the reinforced fibers (the aggregates) are more likely to receive a large shear force from the thermoplastic resin. In the injection molding apparatus 10, however, the secondary hopper 19 is placed on the tip opening side of the injection cylinder 15 relative to the primary hopper 18, and the thermoplastic resin and the fiber reinforced aggregates are separately supplied to the primary hopper 18 and the secondary hopper 19. Accordingly, the reinforced fibers (the aggregates) supplied to the injection cylinder 15 from the secondary hopper 19 are mixed with the thermoplastic resin that is sufficiently kneaded to have a low viscosity. Accordingly, the reinforced fibers (the aggregates) are less likely to receive a large shear force from the thermoplastic resin.

This makes it possible to restrain an overall length of the reinforced fibers dispersed in the thermoplastic resin inside the injection cylinder 15 from becoming largely shorter than the reinforced fibers right after being supplied to the injection cylinder 15 from the secondary hopper 19. This allows a resin molded product to easily have good material properties as compared with a conventional injection molding apparatus.

Further, the pitch of the screw 20 gradually decreases as it goes from the opposed part 24a opposed to the secondary hopper 19 toward the tip opening side of the injection cylinder 15. That is, a thrust generated by the screw 20 gradually increases as it goes to the tip opening side of the injection cylinder 15 from the opposed part 24a. This makes it possible to uniformly disperse, in the thermoplastic resin, the fiber reinforced aggregates in the injection cylinder 15 while defibrating the fiber reinforced aggregates by the screw 20.

The pitch of the opposed part 24a of the screw 20 may be larger than a pitch of a part adjacent to the opposed part 24a from a primary hopper 18 side.

In this case, a pressure of the thermoplastic resin decreases as the thermoplastic resin moves from the primary hopper 18 side of the screw 20 toward the opposed part 24a. This makes it possible to restrain a vent-up phenomenon in which the thermoplastic resin sent to the opposed part 24a rises toward a secondary-hopper-19 side due to its own pressure. Accordingly, it is possible to surely supply, to the injection cylinder 15, the reinforced fibers supplied to the secondary hopper 19.

The embodiment of the present invention has been described above, but the present invention should not be limited to the embodiment. For example, a mixing element (e.g., a Madoc type, a Dulmage type, a pin type, and the like) to promote dispersion of the reinforced fibers in the molten resin may be provided in a tip end (a side closer to the nozzle 16 than the flight portion 22) of the screw 20.

A pressure sensor for detecting the pressure of the molten resin may be provided in a part opposed to the secondary hopper 19 inside the injection cylinder 15, so as to adjust, by use of an output of the pressure sensor, supply amounts of the resin pellets and the modifier to be put into the primary hopper 18 by first feed means and a supply amount of the fiber reinforced aggregates to be put into the secondary hopper 19 by second feed means. With such a configuration, it is possible to surely prevent vent-up of the mixture of the resin pellets and the modifier toward the secondary-hopper-19 side.

What is claimed is:

1. An injection molding apparatus comprising:
an injection cylinder having a tip opening communicating with a cavity of a molding die;
a resin supply portion configured to supply thermoplastic resin to a space in the injection cylinder;
a reinforced fiber supply portion configured to supply fiber reinforced aggregates to the space in the injection cylinder; and
a screw rotatably disposed in the injection cylinder, the screw being configured to compress and knead the thermoplastic resin in the injection cylinder and defibrate the fiber reinforced aggregates so as to disperse the fiber reinforced aggregates in the thermoplastic resin, wherein:
the resin supply portion and the reinforced fiber supply portion are provided as different bodies,
the reinforced fiber supply portion is placed on a tip opening side relative to the resin supply portion; and
the screw has a uniform groove depth.

2. The injection molding apparatus according to claim 1, wherein a pitch of the screw gradually decreases as it goes from an opposed part opposed to the reinforced fiber supply portion toward the tip opening side.

3. The injection molding apparatus according to claim 2, wherein a pitch of the opposed part of the screw is larger than a pitch of a part adjacent to the opposed part from a resin-supply-portion side.
